(19) United States
(12) Patent Application Publication
(10) Pub. No.: US 2014/0352635 A1
(43) Pub. Date: Dec. 4, 2014

(54) APPARATUS FOR THE GENERATION OF HYDROGEN FOR INTERNAL COMBUSTION ENGINES

(71) Applicant: Victor Luis San Miguel Beltran, Puerto De Mazarron (ES)

(72) Inventor: Victor Luis San Miguel Beltran, Puerto De Mazarron (ES)

(73) Assignees: Diego Martinez Mendoza, Puerto De Mazarron (ES); Antonio Gonzalez-Amaliach Cano, Puerto De Mazarron (ES)

(21) Appl. No.: 13/879,424

(22) PCT Filed: Oct. 15, 2011
(86) PCT No.: PCT/ES2011/070713

§ 371 Date: Aug. 14, 2014

(30) Foreign Application Priority Data
Oct. 29, 2010 (ES) P201031593

(51) Int. Cl. F02B 43/10

(52) U.S. Cl. CPC F02B 43/10; F02B 2043/106
USPC 123/3

(57) ABSTRACT

Device for generating hydrogen for internal-combustion engines essentially comprising first means for generating hydrogen (H₂) and second means for generating oxygen (O₂) that addresses the technical problem of storing hydrogen, as well as the derived problems of using a substation to produce the fuel required to start and run the positive-ignition engine, increasing the working potential of said engine compared to operation with hydrocarbon and reducing residues to very low levels, clearly benefitting the environment.

The object of the present invention is an electrolytic apparatus for the generation of hydrogen (H₂) for internal combustion engines, in particular petrol engines.

### STATE OF THE PRIOR ART

At the present time, automotive vehicles are provided with an internal combustion engine consuming fuel, principally petrol or diesel oil, although engines are known which consume natural gas, butane gas and other petroleum derivatives. The principal problem is that these fuels are hydrocarbons or hydrocarbon derivatives originating from petroleum and/or other fossil fuels producing a large quantity of contaminant gases, principally carbon dioxide, responsible in great measure for the well-known climate change effect. Furthermore, by virtue of the complexity of the petroleum market the price of petroleum tends to fluctuate as a result of different geostrategic conditions, as a consequence thereof it has become imperative to locate other alternative sources for transport which combine simplicity with low cost.

One of the alternatives which is generating most research is that of the utilization of hydrogen which, on combustion, reacts with oxygen producing water as residual product which, logically, is not a contaminant. Said hydrogen may be utilized in internal combustion engines whether of new design or adapted. An example thereof is Spanish utility model ES 199 600 U “Electrolytic engine” describing a system comprising an electrolytic cell for the decomposition of water into its components, hydrogen and oxygen, which are utilized as fuel in a conventional engine having suitable dimensions, essentially characterized in that the electrolytic cell presents the electrodes thereof in troncoconical shape, disposed in a coaxial sense, acting as pipes for the gases resulting from electrolytic decomposition, which gases in the interior of the engine are reconverted into water through the effect of the spark of the spark plug, the resulting steam passing through the interior of a cooling coil which deposits the water back in the cell, whilst the energy from the crankshaft of the engine is utilized to drive a generator supplying the electricity required for the electrodes and the spark plug.

However, the transport of said hydrogen presents a significant problem by virtue of the fact that it is only possible to handle it in high-pressure compressed-gas tanks or in liquid form in cryogenic tanks. Either of these solutions limits the range of an automobile by virtue of the fact that compressed-gas tanks do not offer high capacity to permit great range. Furthermore, cryogenic tanks are voluminous and very heavy.

To resolve this latter problem, Spanish utility model ES 1 068 680 U “Device for the generation of hydrogen for internal combustion engines” is presented which describes technical particularities destined to optimize the satisfactory production in the vehicle itself of hydrogen which may be easily mixed with the fuel fed to the engine, in this manner it being very simple to adapt this device to a vehicle already in existence, markedly reducing the consumption thereof and contamination therefrom.

In this manner, the device comprises an electrolytic cell having a caustic salt solution in water, said electrolytic cell being connected to the electrical system of the engine through means of control, said electrolytic cell having an outlet for the hydrogen gas produced connected to a mixer inserted in the pipe supplying fuel to the engine, said mixer having associated therewith a previous fuel-ionizing vaporizer, permitting the mixing of the fuel in vapor form and the hydrogen prior to the feeding thereof to the engine. As a consequence, the fuel utilized, principally petrol, is enriched with the hydrogen prior to entering the engine, achieving a significant reduction in said fuel consumption and, furthermore, a considerable reduction in the emission of carbon dioxide through the realization of the supplement of hydrogen.

### EXPLANATION OF THE INVENTION

One object of the present invention is to present a new apparatus for the generation of hydrogen by electrolysis in internal combustion engines not requiring voluminous fuel storage nor the employment of a substation for the production of the fuel required for starting and running the explosion engine, increasing the output power of the said engine with respect to the operation thereof with hydrocarbons and reducing residual products to very low levels, obtaining a clear environmental advantage.

More specifically, the apparatus for the generation of hydrogen for internal combustion engines, the object of the present invention, essentially comprises first means of generation of hydrogen (H₂) and second means of generation of oxygen (O₂), characterized in that said first means of generation of hydrogen are based on means of electrolytic separation of the hydrogen configured to distribute the hydrogen and oxygen along their respective lines of generation. In this manner, the hydrogen firstly passes through a first check valve comprising two inlets, a first principal inlet of hydrogen and a second return inlet (2b) of hydrogen not used in combustion and/or storage in the hydrogen cell.

Said first means comprise a filter for the hydrogen situated prior to the inlet of the hydrogen into means of regulation of the pressure and flow of the hydrogen before the passage thereof through the carburetion itself of the combustion engine.

Hydrogen not employed in combustion passes to a hydrogen cell together with the oxygen received from the second means of generation of oxygen which, on the one hand, generates an electric current which can be exploited in the engine and, on the other hand, a residual output of water and air which can be exploited for the replenishment of the electrolytic generator and/or the supply of cooling water.

The principal advantage of the present invention lies in the total replacement of a highly-contaminating fuel, such as petrol, by a fuel such as hydrogen which does not produce any type of contaminant residual product, but water, hydroxyl and potassium hydroxide (KOH) vapor which, furthermore are not expelled to the environment in spite of their lack of potential hazardousness.

A further advantage of the invention is the elimination of the massive tanks required for the transport of hydrogen by a small-sized tank of only 3×8 inches, by virtue of the fact that solely the fuel which is utilized is produced, diminishing the possibility of accidents arising from technical flaws or impacts due to the flammable characteristics of hydrogen.

The increase in output power with respect to hydrocarbons is due to the fact that in the combustion chamber itself, and by virtue of the characteristics of hydrogen ignition and a strong spark, detonation is improved.

Throughout the description and claims the word “comprises” and variants thereof do not have the intention of excluding other technical characteristics, additives, components or steps. For experts in the art, other objects, advantages and characteristics of the invention will emerge, in part from the description and in part from the practice of the invention. The following examples and drawings are provided in terms of illustration and they are not intended to limit the present invention. Moreover, the present invention covers all the possible combinations of specific and preferred embodiments herein indicated.

### BRIEF DESCRIPTION OF THE DRAWINGS

FIG. 1 shows a schematic view of the apparatus for the generation of hydrogen for internal combustion engines, the object of the present invention.

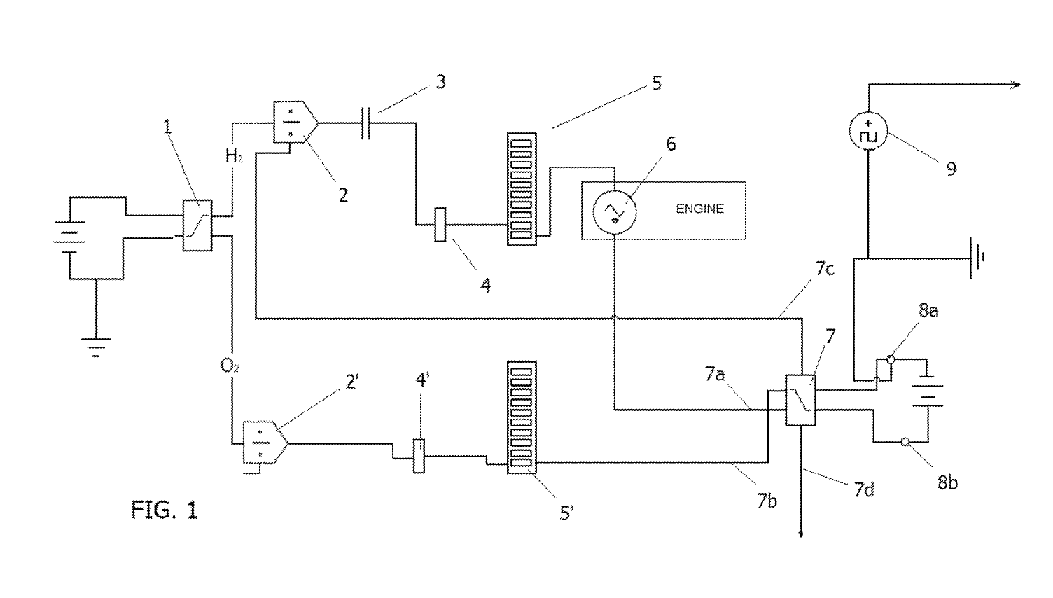

### DETAILED EXPOSITION OF AN EMBODIMENT OF THE INVENTION

As may be observed in the attached figure, the apparatus object of the present invention comprises essentially first means of generation of hydrogen H₂ and second means of generation of oxygen O₂. Said first means of generation of hydrogen are based on means of electrolytic separation of hydrogen 1 configured to distribute the hydrogen and the oxygen along their respective lines of generation (H₂, O₂).

The hydrogen passes firstly through a first check valve 2 comprising two inlets, a first principal inlet of hydrogen 2a and a second return inlet 2b of hydrogen not used in the combustion and/or storage in the hydrogen cell 7, permitting the reutilization of the surplus hydrogen during the process and, as a consequence thereof, minimizing the quantity of hydrogen to be produced in the first stage of electrolytic generation 1.

Subsequently, and following the passage thereof through check valve 2, the hydrogen is filtered by means of a filter 3 of special polymers configured to obtain hydrogen of greater purity, said hydrogen being temporarily stored in a tank 4, followed by a pressure gauge 5 which regulates the pressure and flow of the hydrogen prior to the passage thereof through the engine itself 6 and the carburetion thereof.

Hydrogen not employed in the combustion 6 is not wasted but ends up in a hydrogen cell 7 together with the oxygen received from the second O₂ means. Said cell 7 comprises, in turn, a first hydrogen inlet 7a, a second oxygen inlet 7b, a first surplus hydrogen return outlet 7c and a second outlet of water and purer air 7d for the replenishment of the generator itself and/or supply of cooling water.

The hydrogen cell 7 furthermore comprises an anode 8a and a cathode 8b which determine a given electric current having the possibility of being employed in the vehicle itself. Moreover, said current may be increased through spark generator means 9 in such a manner that said current may be employed in the spark plugs for the generation of the explosion necessary for the combustion of the hydrogen 6.

Finally, the second means of generation of oxygen are also based on the electrolytic means of separation of the hydrogen 1 which liberate oxygen which passes through a first check valve 2′, passing subsequently to a tank 4′, followed by a pressure gauge 5′ which regulates the pressure and flow of the oxygen prior to its direct passage to the hydrogen cell 7.

1. An apparatus for the generation of hydrogen for internal combustion engines essentially comprising first means of generation of hydrogen (H₂) and second means of generation of oxygen (O₂), wherein
said first means of generation of hydrogen are based on means of electrolytic separation of the hydrogen, configured to distribute the hydrogen and oxygen along their respective lines of generation (H₂, O₂), and wherein the hydrogen firstly passes through a first check valve comprising two inlets, a first principal inlet of hydrogen and a second return inlet of hydrogen unused in the combustion and/or storage in the hydrogen cell;
and in that said first means comprise a filter of the hydrogen situated prior to the inlet of the hydrogen into means of regulation of the pressure and flow of the hydrogen prior to the passing thereof through the carburettor itself of the combustion engine;
and in that the hydrogen not employed in the combustion passes to a hydrogen cell in conjunction with the oxygen received from the second means of generation of oxygen which, on the one hand, generates an electric current which can be exploited in the engine, together with a residual outlet of water and air capable of being exploited for the replacement of the electrolytic generator and/or the supply of cooling water.

2. The apparatus as claimed in claim 1, wherein the hydrogen is filtered subsequent to the passage thereof through the check valve by means of a filter of special polymers configured to obtain hydrogen of greater purity.

3. The apparatus as claimed in claim 1, wherein the hydrogen cell furthermore comprises an anode and a cathode which determine a given electric current having the possibility of being employed in the vehicle itself.

4. The apparatus as claimed in claim 1, wherein the electric current may be increased through spark generator means in such a manner that said current may be employed in the spark plugs for the generation of the explosion necessary for the combustion of the hydrogen.

5. The apparatus as claimed in claim 1, wherein the second means of generation of oxygen are also based on the electrolytic means of separation of the hydrogen which liberate oxygen, which passes through a first check valve, passing subsequently to a tank, followed by a pressure gauge which regulates the pressure and flow of the oxygen prior to its direct passage to the hydrogen cell.
